(19) United States
(12) Patent Application Publication
(10) Pub. No.: US 2005/0284805 A1
(43) Pub. Date: Dec. 29, 2005

(54) Filter plate

(76) Inventors: Olli Hognabba, Kantvik (FI); Bjarne Ekberg, Turku (FI); Veikko Varjonen, Turku (FI); Dave B. Eveland, Bloomfield, NY (US); Jeffrey J. Yost, Newark, NY (US)

Correspondence Address: KUBOVCIK & KUBOVCIK, SUITE 710, 900 17TH STREET NW, WASHINGTON, DC, 20006, US

(21) Appl. No.: 10/527,459

(22) PCT Filed: Sep. 4, 2003
(86) PCT No.: PCT/FI03/00645

§ 371 Date: Mar. 11, 2005

(30) Foreign Application Priority Data
Sep. 12, 2002 (FI) 20021631

(51) Int. Cl. B01D 65/02

(52) U.S. Cl. 210/321.69; 210/231; 210/321.84; 210/498; 210/486

(57) ABSTRACT

The invention relates to a microporous filter plate to be used in a suction drier, particularly in a capillary filter, the filter plate of which contains a membrane with a mean pore size of about 1 micrometer, a substrate, whereon the membrane is positioned, and a recessed area in the interior of the filter plate with cavities for a filtrate and for a backwash liquid. According to the invention the recessed area in the interior of the filter plate is provided with supporting elements, in which the ratio between the longest dimension and the shortest dimension is in maximum 1.5 in the cross-section parallel to the filtration surface of the filter plate, for allowing liquid to flow essentially simultaneously and easily in all directions and for the structure of the filter plate being durable for stresses based on pressure peaks.

This invention relates to a microporous filter plate to be used in a suction drier, particularly in a capillary filter. The filter plate is especially an improvement in pressure shock resistance.

The U.S. Pat. No. 4,863,656 relates to a method for manufacturing a microporous plate, a filter plate obtained from the method, and a suction drier apparatus utilizing such filter plates are disclosed. The filter plate of this U.S. Pat. No. 4,863,656 comprises a pair of opposed suction walls defining an interior space between them, which is filled with a granular material. The suction drier apparatus includes at least one of the filter plates which is mounted to be moved into and out of a basin or the like in which material to be dewatered is present. In one embodiment, the suction drier apparatus includes several filter plates mounted in a circular array around a rotating shift. A negative pressure is applied to the suction walls of each plate whereby water or other liquid is suctioned from the material to be dewatered through the suction walls into the interior space within the filter plate and then drawn under the negative pressure out of the plate structure.

The U.S. Pat. No. 5,178,777 relates to a method for removing a filter cake from a capillary surface, when the liquid in the creation of the filter cake is sucked through the filter surface of the filter element. In this U.S. Pat. No. 5,178,777 on the filter surface of the filter element there is formed a liquid film by means of reversed pressure effected through the filter element in order to make a backwash effect to the filter plate. Essentially immediately after the creation of the liquid film, at least one gas blowing is directed to the filter surface of the filter element in order to detach the filter cake located on the filter surface.

The microporous filter plate used in capillary filters are thus designed to withstand continuous pressure changes from about 0,1 bar absolute during the cake building and drying sequence to about 2,0 bar absolute during the backwash sequence. The plates have to be able to withstand this pressure change once every revolution, which means about half a million pressure chocks per year. Therefore, it is obvious that the strength of the microporous filter plate has to be extremely high in order for the plate to survive for years in rather harsh environments.

A backwash pressure of 2.0 bar absolute does not seem like a too high of a pressure for porous filter plate to withstand. Nevertheless, it has been found out that the plates are subjected to much higher pressures than what the backwash pressure is set on. This is due to the collapsing of expanded gas when changing from vacuum mode to the backwash mode. Rushing water causes a water-hammer effect inside the plate, which can cause a short pressure peak of up to 10 bar or sometimes even higher. In addition to the strength requirements, an optimized liquid flow requires an internal substrate structure of minimal pressure drop. This is important during the cake forming stage but especially important during the backwash sequence. Insufficient backwashing causes the filter plates to clog too fast, which decreases the capacity of the filter. Furthermore, when the filter plates are clogged, the flow resistance increases and the risk for damaging pressure shocks increases.

The filter plate used in capillary filters advantageously contains a membrane with a mean pore size of about 1 micrometer and a substrate with a mean pore size of 10 micrometer, filtrate/backwash channels, filtrate/backwash outlet/inlet and mounting holes/hubs for mounting the filter plate to a filtration equipment. The structure has enough strength and good flow properties, in terms of both filtrate removal and backwashing capacity. However, if the conditions are such that high-pressure peaks are experienced, a structure with higher strength combined with optimal flow properties is required. An un-optimized flow design creates an uneven pressure distribution inside the filter plates. The structure which is designed and optimized for a backwash pressure of maximum 2 bar absolute does not work in conditions where pressure peaks occur, but the pressure causes stresses in the plates, high enough for them to burst.

The object of the present invention is to eliminate some drawbacks of the prior art and to achieve an improved filter plate to be used in a suction drier, particularly in a capillary filter, the filter plate of which has to withstand continuous pressure shocks, and still maintains good flow properties. The essential features of the invention are enlisted in the appended claims.

The filter plate of the invention to be used in a suction drier, particularly in a capillary filter, contains a membrane with a mean pore size of about 1 micrometer and a substrate, whereon the membrane is positioned. In the interior of the filter plate there is a recessed area with cavities for a filtrate and for a backwash liquid. The filter plate is also provided with at least one outlet or inlet for the filtrate and for the backwash liquid as well as with mounting holes or hubs for attaching the filter plate to the suction drier itself. The recessed area inside the filter plate according to the invention is provided with supporting elements, which may be part of the substrate or separate elements. The positions of supporting elements allow liquid separated from the filtered solid material or liquid used in the backwash to flow essentially simultaneously and easily in all directions, for instance both horizontally and vertically, but on the other hand the positions of supporting elements are so determined that the structure of the filter plate is durable for stresses caused by pressure peaks. Further, the substrate material is coarser and more porous compared to the prior art and thus the liquid separated from the filtered solid material is easier to flow inside the substrate material. Because the flow resistance is thus minimized, the pressure peaks are decreased and the filter plate of the invention is more durable.

When thinking the positions of supporting elements in the recess space of the filter plate the ideal situation for the liquid flow is a completely open interior and the ideal situation for strength is a completely closed interior. On one hand, an open space is needed for fluid and on other hand, supporting elements are needed between the walls of the recess space for stress resistance, the shape and the amount of supporting elements are optimized using the design with enough total area of supporting elements and using a small enough distance between supporting elements.

The supporting elements of the invention contain 10 to 50%, advantageously 15 to 30%, of the total area of the recessed area at a substrate tensile strength of 10-40 MPa and at a substrate thickness of 10 to 15 millimeter (each side of the recessed area). Further, the supporting elements are so positioned, that the distance between the supporting elements withstands high internal pressure and is maximum 75 millimeter from an edge of a supporting element to an edge of another supporting element at the same tensile strength of 10-40 MPa and at the same material thickness of 10 to 15 millimeter. It is obvious that when the material properties for the membrane will be changed also the amount of the supporting elements and the distance from one supporting element to another supporting element will be changed accordingly.

The position and shape of the supporting elements are thus such that straight stress lines are advantageously avoided inside the filter plate of the invention. This is achieved by the placement of the supporting elements or by variable sized and shaped supporting elements. The supporting elements can be of any shape, preferable round or oval, however in any case such that the ratio between the longest dimension and the shortest dimension is in maximum 1.5 in the cross-section parallel to the filtration surface of the filter plate. The edge around the recessed area can be of any shape but preferable of a curvature shape that disrupts any stress lines. One preferred shape for the supporting element is a circular button.

In order to further prevent the pressure peaks in the filter plate of the invention the substrate material of the filter plate is made coarser and/or more porous than in the prior art to allow the liquid to flow easier inside the substrate in that direction of discharging from the interior of the substrate into the recessed area and further in the recessed area itself. The substrate contains particles so that the mean pore size in the substrate is between 5 and 90 micrometer, preferably between 10 and 60 micrometer. The porosity range is 25-80%, preferably 40-50%, of the total volume of the substrate.

The membrane and the substrate of the filter plate of the invention are advantageously made of the same material; only the particle size is different. The membrane and the substrate can also be made of different materials. The filter plate of the invention is preferable made of at least one of ceramic materials such as alumina, silicon carbide, silica, titania, zirconium oxide and chromium oxide, which are sintered or glass bonded. Other materials, such as graphite, amorphous carbon, sintered metals, plastics and cellulose can also be applied. Further, the filter plate of the invention can also be applied in conventional vacuum disc filters.

The invention is in more details described in the following referring to the enclosed drawings where

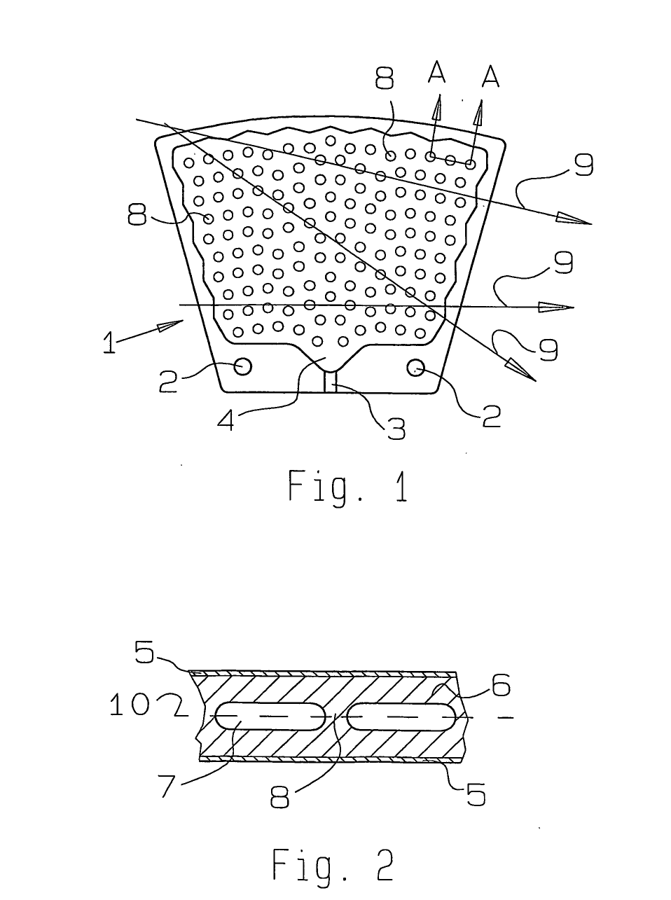

FIG. 1 illustrates one preferred embodiment of the invention as a partly split side view,

FIG. 2 illustrates the embodiment of FIG. 1 seen partly from the direction A-A,

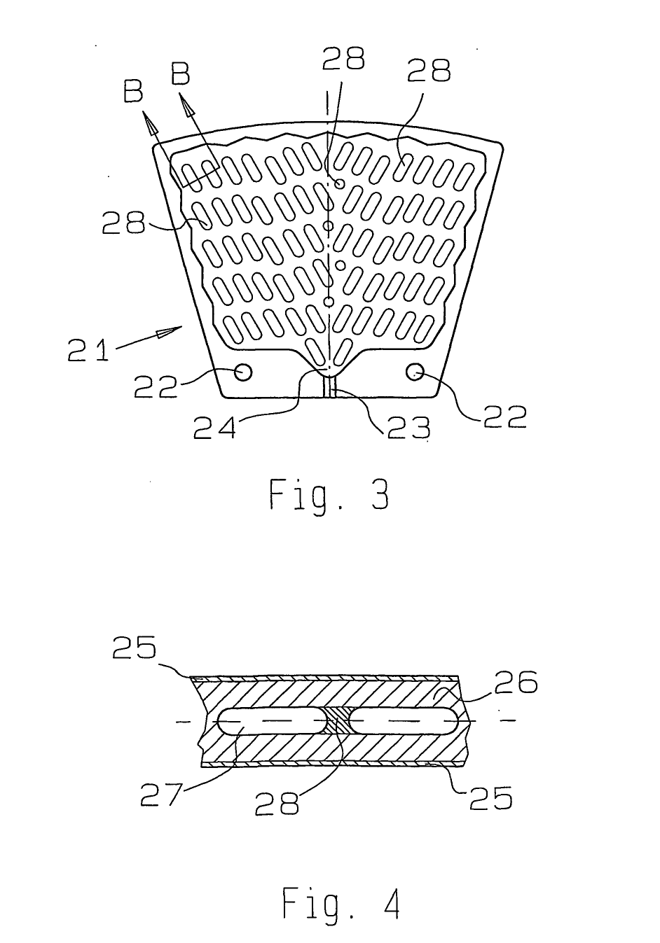

FIG. 3 illustrates another preferred embodiment of the invention as a partly split side view,

FIG. 4 illustrates the embodiment of FIG. 2 seen partly from the direction B-B.

According to FIGS. 1 and 2 the filter plate 1 is provided with mounting holes 2 to be attached to a suction dryer (not shown). The filter plate 1 is further provided with an outlet 3 through which the filtrate is removed from the interior 4 of the filter plate 1. The area in the filter plate 1 which is used for the filtration itself contains a membrane 5 with a mean pore size of about 1 micrometer and a substrate 6, whereon the membrane 5 is positioned. The substrate 6 has in its interior recess areas 7 and between these recess areas there are positioned supporting elements 8. The supporting elements 8 are made of the same material as the substrate 6 and these supporting elements 8 are shaped as circular buttons in the cross-section 10 parallel to the filtration surface of the filter plate 1.

When using the filter plate 1 of the invention in the filtration process the filtrate flows through the porous membrane 5 to the substrate 6 and further through the pores in the substrate 6 into the interior 4. The filtrate will further flow through the recess areas 7 to the outlet 3.

FIG. 1 is also provided with some stress lines 9 in order illustrate the positions of the supporting elements 8 for preventing straight stress lines because the stress lines 9 go through at least one supporting element 8.

According to FIGS. 3 and 4 the filter plate 21 of the invention is provided with mounting holes 22 to be attached to a suction dryer (not shown). The filter plate 21 is also provided with an outlet 23 through which the filtrate is removed from the interior 24 of the filter plate 21. The area in the filter plate 21, which is used for the filtration itself, contains a membrane 25 with a mean pore size of about 1 micrometer and a substrate 26, whereon the membrane 25 is positioned. The substrate 26 has in its interior recess areas 27 and between these recess areas 27 there are positioned supporting elements 28. The supporting elements 28 are made of the different material as the substrate 26. The supporting elements 28 are partly shaped as circular buttons, but most of the supporting elements 28 have different kind of a shape.

When using the filter plate 21 of the invention in the filtration process the filtrate flows through the filter plate 21 in similar manner as described above for the embodiment of FIG. 1.

1. Microporous filter plate to be used in a suction drier, particularly in a capillary filter, the filter plate of which contains a membrane with a mean pore size of about 1 micrometer, a substrate, whereon the membrane is positioned, and a recessed area in the interior of the filter plate with cavities for a filtrate and for a backwash liquid, and also provided with at least one outlet or inlet for the filtrate and for the backwash liquid outlet/inlet as well as with mounting holes or hubs for attaching the filter plate to the suction drier, characterized in that the recessed area in the interior of the filter plate is provided with supporting elements, in which the ratio between the longest dimension and the shortest dimension is in maximum 1.5 in the cross-section parallel to the filtration surface of the filter plate, for allowing liquid to flow essentially simultaneously and easily in all directions and for the structure of the filter plate being durable for stresses based on pressure peaks.

2. Filter plate according to the claim 1, characterized in that the supporting elements in the recessed area contain 10 to 50% of the total area of the recessed area.

3. Filter plate according to claim 1, characterized in that the supporting elements are so positioned, that the distance between the supporting elements is maximum 75 millimeter from an edge of a supporting element to an edge of another supporting element.

4. Filter plate according to claim 1, characterized in that the supporting element has a curvature shape.

5. Filter plate according to claim 1, characterized in that the supporting element is a circular button in shape.

6. Filter plate according to claim 1, characterized in that the supporting element is of an angular shape.

7. Filter plate according to claim 6, characterized in that the supporting element is a square in shape.

8. Filter plate according to claim 6, characterized in that the supporting element is a triangle in shape.

9. Filter plate according to claim 6, characterized in that the supporting element is a hexagon in shape.

10. Filter plate according to claim 1, characterized in that the supporting element is part of the substrate.

11. Filter plate according to claim 1, characterized in that the mean pore size in the substrate is between 5 and 90 micrometer, preferably between 10 and 60 micrometer.

12. Filter plate according to claim 1, characterized in that the porosity range in the substrate is 25-80% of the total volume of the substrate.

13. Filter plate according to claim 1, characterized in that the membrane and the substrate is made of the same material.

14. Filter plate according to claim 1, characterized in that the membrane and the substrate is made of different materials.

15. Filter plate according to claim 1, characterized in that at least one ceramic material is used for manufacturing the filter plate.

16. Filter plate according to claim 1, characterized in that at least one sintered metal is used for manufacturing the filter plate.

17. Filter plate according to claim 1, characterized in that at least one plastics material is used for manufacturing the filter plate.

18. Filter plate according to claim 1, characterized in that at least one carbon based material is used for manufacturing the filter plate.

19. Filter plate according to the claim 2, characterized in that the supporting elements in the recessed area contain 15 to 30% of the total area of the recessed area.

20. Filter plate according to claim 12, characterized in that the porosity range in the substrate is 40-50% of the total volume of the substrate.
